(19) United States
(12) Patent Application Publication
(10) Pub. No.: US 2025/0389140 A1
(43) Pub. Date: Dec. 25, 2025

(54) SLIDER MECHANISM FOR A VEHICLE GLOVE BOX

(71) Applicant: GM GLOBAL TECHNOLOGY OPERATIONS LLC, Detroit, MI (US)

(72) Inventors: Arul Thirumurugan M, Coimbatore (IN); Vignesh RAJENDIRAN, Tirupattur (IN)

(21) Appl. No.: 18/753,694

(22) Filed: Jun. 25, 2024

(51) Int. Cl. E05B 83/30; B60R 7/06

(52) U.S. Cl. CPC E05B 83/30; B60R 7/06

(57) ABSTRACT

A glove box assembly for a vehicle includes a glove box compartment pivotally mounted within a recess of a dashboard. A pair of laterally spaced locking snaps mounted to a frame of the dashboard above the recess, the pair of locking snaps each include a hook end and a beveled end surface. A slider mechanism is mounted to the glovebox and engageable with the pair of locking snaps, wherein the slider mechanism includes a fixed inner rail mounted to an interior of the glove box compartment and a movable outer rail slidably mounted to the fixed inner rail, the fixed inner rail and the movable outer rail each include a pair of slots that each receive a respective one the pair of locking snaps.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a slider mechanism for a vehicle glove box.

Glove box latch mechanisms typically occupy a significant amount of space within the glovebox and limit the usable space of the glove box. In addition, existing glove box latch mechanisms have a relatively complex construction. Accordingly, it is desirable to provide a glove box slider mechanism that is simple in construction and that takes up less space within the glove box compartment.

### SUMMARY

According to an aspect of the present disclosure, a glove box assembly for a vehicle includes a glove box compartment pivotally mounted within a recess of a dashboard. At least one locking snap is mounted to a frame of the dashboard above the recess. A slider mechanism is mounted to the glovebox and engageable with the locking snap.

According to another aspect, the at least one locking snap includes a pair of locking snaps laterally spaced from one another along the frame.

According to another aspect, the pair of locking snaps each include a hook end.

According to another aspect, the pair of locking snaps each include beveled end surface.

According to another aspect, the slider mechanism includes a fixed inner rail mounted to an interior of the glove box compartment and a movable outer rail slidably mounted to the fixed inner rail.

According to another aspect, the fixed inner rail and the movable outer rail each include a slot that each receive the at least one locking snap.

According to another aspect, a sliding knob is connected to the movable outer rail and extends through an aperture in a front face of the glove box compartment.

According to another aspect, a spring is provided for biasing the movable outer rail to a latching position.

According to another aspect, the fixed inner rail is mounted to a glove box inner liner.

According to a further aspect, the glove box assembly for a vehicle includes a glove box compartment pivotally mounted within a recess of a dashboard. A pair of laterally spaced locking snaps are mounted to a frame of the dashboard above the recess. The pair of locking snaps each include a hook end and a beveled end surface. A slider mechanism is mounted to the glovebox and engageable with the pair of locking snaps.

According to another aspect, the slider mechanism includes a fixed inner rail mounted to an interior of the glove box compartment and a movable outer rail slidably mounted to the fixed inner rail.

According to another aspect, the fixed inner rail and the movable outer rail each include a slot that each receive the at least one locking snap.

According to another aspect, a sliding knob is connected to the movable outer rail and extends through an aperture in a front face of the glove box compartment.

According to another aspect, a spring biases the movable outer rail to a latching position.

According to another aspect, the fixed inner rail is mounted to a glove box inner liner.

According to further aspect, a glove box assembly for a vehicle includes a glove box compartment pivotally mounted within a recess of a dashboard. A pair of laterally spaced locking snaps mounted to a frame of the dashboard above the recess, the pair of locking snaps each include a hook end and a beveled end surface. A slider mechanism is mounted to the glovebox and engageable with the pair of locking snaps, wherein the slider mechanism includes a fixed inner rail mounted to an interior of the glove box compartment and a movable outer rail slidably mounted to the fixed inner rail, the fixed inner rail and the movable outer rail each include a pair of slots that each receive a respective one the pair of locking snaps.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a plan view of a glove box in a dash of a vehicle according to the principles of the present disclosure;

FIG. 2 is a perspective view of the glove box slider mechanism according to the principles of the present disclosure;

FIG. 2A is a detailed perspective view of the glove box slider mechanism engaged with the snap of the present disclosure;

FIG. 3 is a schematic view of the glove box slider mechanism according to the principles of the present disclosure;

FIG. 4 is a schematic view of the glove box slider mechanism according to the principles of the present disclosure shown in a locked position;

FIG. 5 is a schematic view of the glove box slider mechanism according to the principles of the present disclosure shown in an unlatched position;

FIG. 6 is a schematic view of the glove box slider mechanism according to the principles of the present disclosure shown in an open position; and

FIG. 7 is a perspective view of a glove box compartment according to the principles of the present disclosure.

In the drawings, reference numbers may be reused to identify similar and/or identical elements.

### DETAILED DESCRIPTION

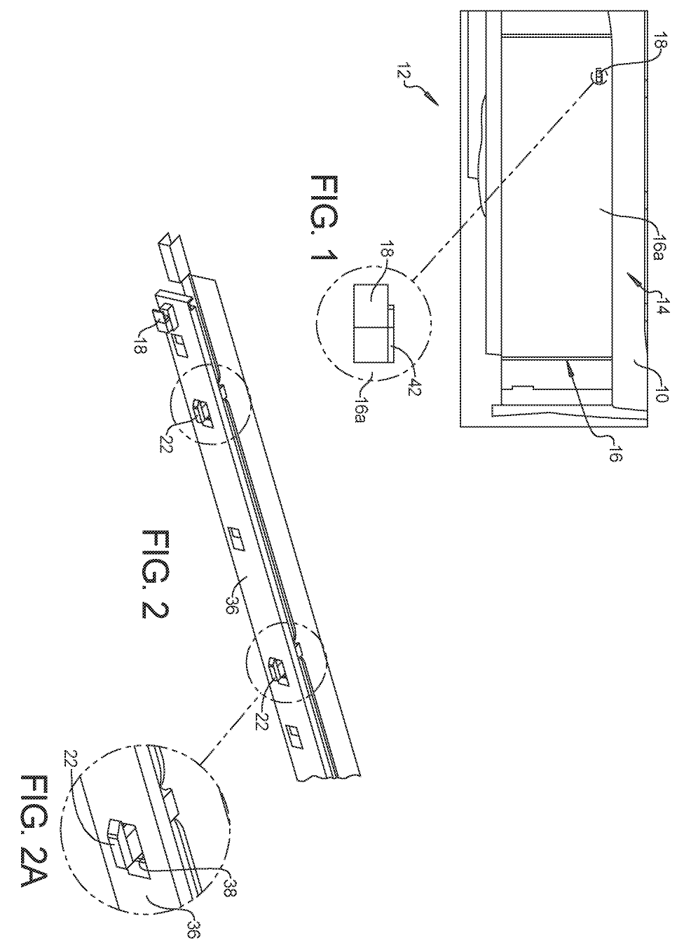

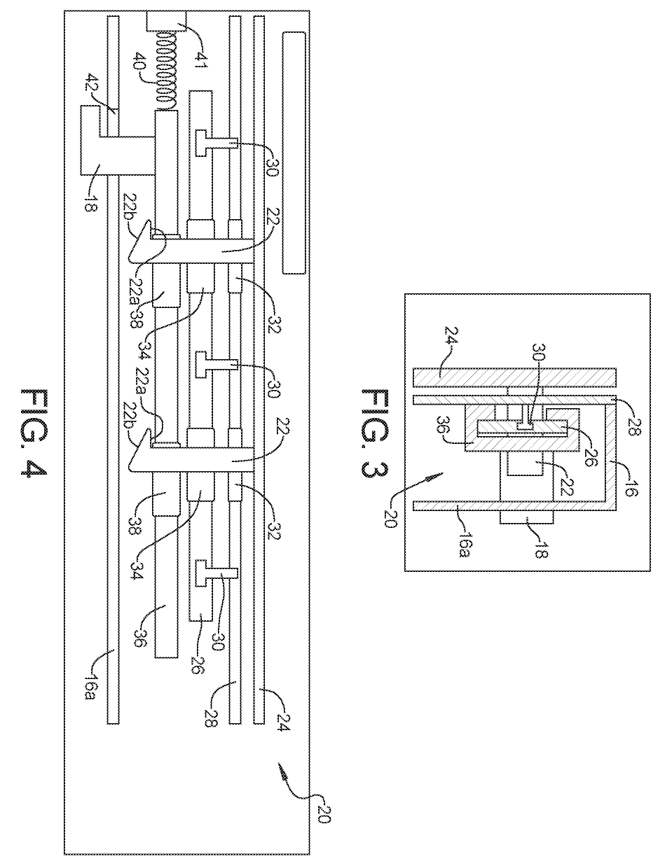

With reference to FIG. 1, a portion of a dashboard 10 of a vehicle 12 is shown including a glove box assembly 14. The glove box assembly 14 includes a glove box compartment 16 (best shown in FIG. 7) that is pivotally received in a recess in the vehicle dashboard 10. The glove box compartment 16 includes a sliding knob 18 on a front face 16a of the glove box compartment 16. The sliding knob 18 is connected to a slider mechanism 20 (See FIG. 7) that is mounted on an interior of the front face 16a of the glove box compartment 16.

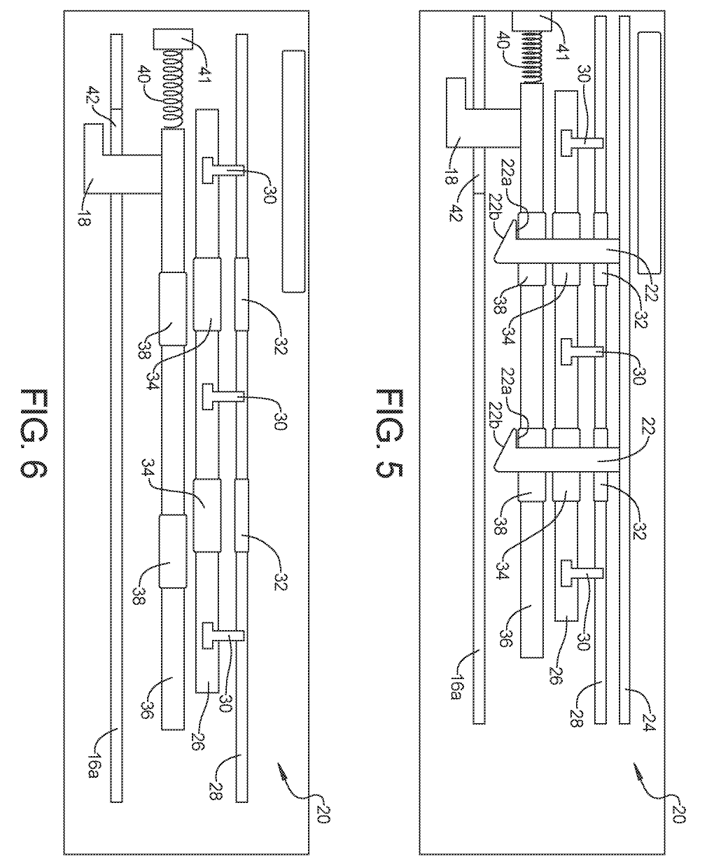

With reference to FIG. 4-6, the slider mechanism 20 engages one or more locking snaps 22 (two are shown) mounted to a door compartment frame 24 that is mounted to or part of the dashboard 10. The slider mechanism 20 includes a fixed inner rail 26 that is mounted to an interior glove box liner 28 by threaded fasteners 30. The interior glove box liner 28 includes a pair of slots 32 that receive the locking snaps 22 therethrough. The fixed inner rail 26 also includes a pair of slots 34 aligned with the pair of slots 32 in the interior glove box liner 28 that also receive the locking snaps 22 therethrough.

An outer movable rail 36 is slidably mounted to the fixed inner rail 26. The outer movable rail 36 also includes a pair of slots 38 that correspond to the slots 32 and 34. A spring 40 is disposed against the outer movable rail 36 and biases the outer movable rail 36 to a latched position where an edge of the slots 38 engage with a hook end 22a of the locking snaps 22 in order to secure the glove box compartment 16 in a closed position as illustrated in FIG. 4. The spring 40 can be disposed against a fixed structure 41 between the front face 16a and the interior glove box liner 28. The sliding knob 18 is fixed to the outer movable rail 36 through an aperture 42 in the front face 16a of the glove box compartment 16.

As shown in FIG. 5, the sliding knob 18 can be operated by a user to move the outer movable rail 36 against the bias force of the spring 40 to disengage from the hook end 22a of the locking snaps 22.

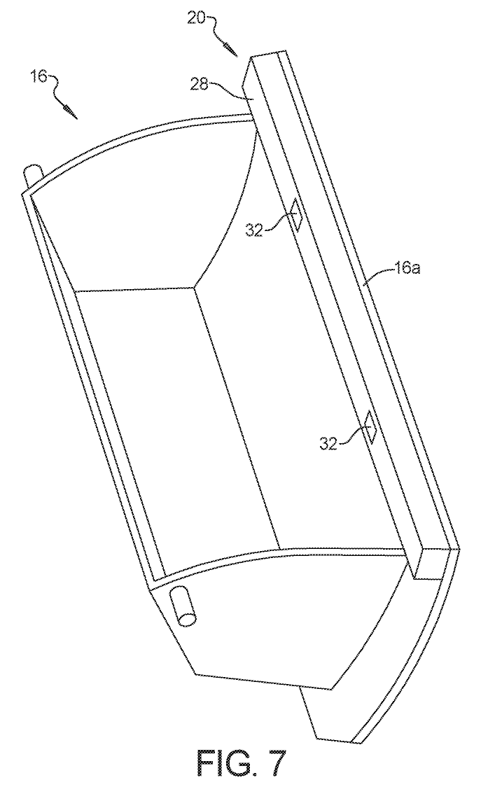

FIG. 6 shows the glove box moved to an open position away from the locking snaps 22. The outer movable rail 36 is shown returned to its latching position by the spring force of the spring 40.

The end of the locking snaps 22 has a beveled surface 22b. When the glove box compartment 16 is moved to a closed position, the locking snaps are received though the slots 32 and 34 in the interior glove box liner 28 and the fixed inner rail 26. Then, the beveled surface 22b of the locking snaps 22 engages the side edge of the slots 38 in the outer movable rail 36 and forces the outer movable rail 36 in a leftward direction against the force of the spring 40 as shown in FIGS. 4-6 so that the hook end 22a of the locking snap is received in the slots 38 and engages the glove box compartment 16 in a closed position.

FIG. 3 is a schematic cross-sectional view of the slider mechanism 20 engaged with a locking snap 22.FIG. 3 shows the locking snap 22 extending from the door compartment frame 24. The locking snap 22 extends through the apertures in the glove box interior liner 28 and fixed inner rail 26. The locking snap 22 can be made from metal or plastic. The fixed inner rail 26 can be a flat plate made from metal or plastic. The fixed inner rail 26 is slidably received in the outer movable rail 36 which can have a C-shaped cross section and can be made from metal or plastic.

The sliding knob 18 is fixed to the outer movable rail 36 and can be integrally formed therewith or otherwise connected to the outer movable rail 36. The sliding knob 18 extends from the outer movable rail and through the slot 42 in the front face 16a of the glove box compartment 16.

The glove box of the present disclosure consists of a slider operated mechanism 20. It provides ease of operation in opening and closing the glove box. The slider mechanism 20 also eliminates the space which is occupied by current latch mechanisms. The slider mechanism 20 is very simple in design, and it consists of fewer parts as compared to the existing latch lever pull handle assemblies. The slider operated mechanism 20 is controlled by the spring 40 and is totally different from the current latch-based glove box mechanism.

This mechanism consists of the outer rail 36 which slides on the fixed inner rail 26 during the operation. The inner rail 26 is attached to the glove box inner door through screws/bolts. Both the rails consist of slots which help in locking and unlocking the fixed snaps which is attached into the door frame/glove box retainer. The sliding knob 18 has a unique simple design which helps in ease of operation as compared with existing latch lever pull handle assemblies.

The reduced size of the slider mechanism 20 increases the storage space/ volume of the glove box container 16 by 15-20% to the user and reduces the weight of the slider mechanism as well.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

1. A glove box assembly for a vehicle, comprising:
a glove box compartment pivotally mounted within a recess of a dashboard;
at least one locking snap mounted to a frame of the dashboard above the recess; and
a slider mechanism mounted to the glovebox and engageable with the locking snap.

2. The glove box assembly according to claim 1, wherein the at least one locking snap includes a pair of locking snaps laterally spaced from one another along the frame.

3. The glove box assembly according to claim 2, wherein the pair of locking snaps each include a hook end.

4. The glove box assembly according to claim 3, wherein the pair of locking snaps each include beveled end surface.

5. The glove box assembly according to claim 1, wherein the slider mechanism includes a fixed inner rail mounted to an interior of the glove box compartment and a movable outer rail slidably mounted to the fixed inner rail.

6. The glove box assembly according to claim 5, wherein the fixed inner rail and the movable outer rail each include a slot that each receive the at least one locking snap.

7. The glove box assembly according to claim 6, further comprising a sliding knob connected to the movable outer rail and extending through an aperture in a front face of the glove box compartment.

8. The glove box assembly according to claim 7, further comprising a spring for biasing the movable outer rail to a latching position.

9. The glove box assembly according to claim 5, wherein the fixed inner rail is mounted to a glove box inner liner.

10. A glove box assembly for a vehicle, comprising:
a glove box compartment pivotally mounted within a recess of a dashboard;
a pair of laterally spaced locking snaps mounted to a frame of the dashboard above the recess, the pair of locking snaps each include a hook end and a beveled end surface; and
a slider mechanism mounted to the glovebox and engageable with the pair of locking snaps.

11. The glove box assembly according to claim 10, wherein the slider mechanism includes a fixed inner rail mounted to an interior of the glove box compartment and a movable outer rail slidably mounted to the fixed inner rail.

12. The glove box assembly according to claim 11, wherein the fixed inner rail and the movable outer rail each include a slot that each receive the at least one locking snap.

13. The glove box assembly according to claim 12, further comprising a sliding knob connected to the movable outer rail and extending through an aperture in a front face of the glove box compartment.

14. The glove box assembly according to claim 13, further comprising a spring for biasing the movable outer rail to a latching position.

15. The glove box assembly according to claim 11, wherein the fixed inner rail is mounted to a glove box inner liner.

16. A glove box assembly for a vehicle, comprising:
a glove box compartment pivotally mounted within a recess of a dashboard;
a pair of laterally spaced locking snaps mounted to a frame of the dashboard above the recess, the pair of locking snaps each include a hook end and a beveled end surface; and
a slider mechanism mounted to the glovebox and engageable with the pair of locking snaps, wherein the slider mechanism includes a fixed inner rail mounted to an interior of the glove box compartment and a movable outer rail slidably mounted to the fixed inner rail, the fixed inner rail and the movable outer rail each include a pair of slots that each receive a respective one the pair of locking snaps.

17. The glove box assembly according to claim 16, further comprising a sliding knob connected to the movable outer rail and extending through an aperture in a front face of the glove box compartment.

18. The glove box assembly according to claim 17, further comprising a spring for biasing the movable outer rail to a latching position.

19. The glove box assembly according to claim 18, wherein the fixed inner rail is mounted to a glove box inner liner.

20. The glove box assembly according to claim 19, wherein the spring is disposed against a structure between the glove box inner liner and the front face of the glove box compartment.
